(19) United States
(12) Patent Application Publication
(10) Pub. No.: US 2006/0135664 A1
(43) Pub. Date: Jun. 22, 2006

(54) Methods and compositions of matter for treatment of cellulose

(76) Inventors: David Glassel, Spring, TX (US); Gary Ernest Mellema, Grapevine, TX (US)

Correspondence Address: Martin L. McGregor, 26415 Oak Ridge Drive, Spring, TX, 77380, US

(21) Appl. No.: 11/303,795

(22) Filed: Dec. 15, 2005

Related U.S. Application Data
(63) Continuation-in-part of application No. 11/016,627, filed on Dec. 17, 2004.
(63) Continuation-in-part of application No. 11/016,636, filed on Dec. 17, 2004.
(63) Continuation-in-part of application No. 11/016,637, filed on Dec. 17, 2004.

(51) Int. Cl. C09D 11/02; C08L 83/04

(52) U.S. Cl. 524/270; 524/588

(57) ABSTRACT

The invention at its most basic is a process for improving the dimensional stability of wood by reducing the fluctuation in the wood fibers caused by changes in moisture content. This is accomplished by carrying a reactive silicone polymer into the wood to contact the internal micro pore structure of the wood, and altering the properties of the wood fiber so that less change in volume occurs with changes in moisture content. The invention may be viewed as a method of treatment useful for improving the properties of wood for use as a construction material that comprises contacting wood with at least one component selected from the group consisting of: (1) an aliphatic solvent composed primarily of C₇-C₁₆ straight chain aliphatic, cycloparaffinic and isoparaffinic hydrocarbons, that contains less than 0.5% aromatics; (2) a natural product oil and further comprising at least one (3) silicone based polymer that forms a film in the presence of a catalyst and water comprising at least one component selected from the group consisting of (A) a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and (B) (MₐD_{b}T_{c}Q_{d})ₓ formula the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group.

### RELATED APPLICATIONS

This application is a continuation in part of U.S. patent application Ser. Nos. 11/016,627, 11/636 and 11/637 filed Dec. 17, 2004.

### TECHNICAL FIELD

This invention provides methods and compositions of matter for protecting cellulose materials such as wooden materials from moisture.

### BACKGROUND OF THE INVENTION

Preservation of construction materials by treatment with various agents has been practiced for many years. Among the earliest treatments was the application of tars or creosotes to wood such as railway ties that would be in contact with the earth. The number of vehicles that are effective to carry active substances inside the wood is currently very limited. Among the normally used products for treating and conserving wood are water as a carrier of active materials such as inorganic copper or arsenic derivatives, and organics such as pentachlorophenol and creosote. Water is the most commonly used carrier for wood preservatives. However, water is often difficult to remove after treatment. Many treatments do not seal and water penetrates the wood after application causing diffusion of materials from the treated wood into the environment. Further the dimensional stability of wood is affected by conformational changes in the wood fibers as the degree of hydration of the fiber changes. According to a standard text, “Construction: Principles, Materials, and Methods” by Simmons, H. Leslie, Olin, Harold Bennett, New York, N.Y., John Wiley & Sons, Inc. (US), 2001, Chapter 6 page 366 et seq., {Cited below as Simmons et al.} On the average wood fibers absorb “water as fiber hydration amounting to about 30% of the dry weight of the wood at the theoretical zero fiber hydration state (oven dried wood). Softwoods are reported to fluctuate by as much as 0.19 mm (0.075 inch) for each 25.4 mm (1 inch) of face width (computed from Simmons et al. FIG. 6.1-11). The problems created by the absorption of water from the atmosphere are made much more severe because the dimensional changes are not equal in each direction. The changes in the wood fibers are larger in the tangential direction than the radial and smallest in the length parallel to the grain of the wood. The present invention decreases the equilibrium hydration of the wood fibers thereby providing improved dimensional stability and resistance to moisture absorption. The exclusion of moisture also protects wood against biological pests, such as fungi and certain insects, that require water to survive within the wood. The wood surface is rendered less prone to wetting by water and the normally hydrophilic character of wood is rendered more hydrophobic. These changes in the wood are accomplished with a novel composition of matter combining an aliphatic hydrocarbon carrier with a silicone polymer and optionally adding an essential oil for added protective effects. A secret formula wood preservative mixture that claimed to improve dimensional stability was widely marketed in the United States under the trademarks Seasonal and Vaccinol from the 1920's to the late 1950s. Whatever this unknown material contained it is certain that it did not contain the silicone polymers of the present invention that were not available until decades later.

No art was found that teaches altering the internal surfaces of the pore structure of the wood by contacting the wood with a mixture that alters the surface of the internal pores present in the wood to reduce the hydrophilic character of the surface and thereby reduce the penetration of water into the wood by treating the wood with a hydrocarbon solvent carrier, a silicone based polymer and optionally a naturally occurring oil. A method and composition to practice the novel wood treatment are described below.

### SUMMARY OF THE INVENTION

The invention at its most basic is a process for improving the properties of cellulose fibers by reducing changes in moisture content. This is accomplished by carrying a reactive silicone polymer into the material such as wood to contact the internal micro-pore structure of the cellulose, and altering the properties of the cellulose fiber so that less change in volume occurs with changes in moisture content. The invention may be viewed as a method of treatment useful for improving the properties of cellulose fibers that comprises contacting cellulose fibers with at least one component selected from the group consisting of: (1) an aliphatic solvent composed primarily of C₇-C₁₆ straight chain aliphatic, cycloparaffinic and isoparaffinic hydrocarbons, that contains less than 0.5% aromatics; (2) a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and further comprising at least one (3) silicone based polymer that forms a film in the presence of a catalyst and water comprising at least one component selected from the group consisting of (A) a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and (B) a crosslinker of the formula (MₐD_{b}T_{c}Q_{d})x to which the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and (C) a catalyst; and maintaining the contact for a time sufficient to establish a change in the cellulose fiber that provides a decrease in the hydrophilic quality of the cellulose fiber decreasing the penetration rate of water into the material; relative to untreated material from the same source. A preferred method comprises the aliphatic solvent (1) wherein the solvent selected is composed primarily of C₉-C₁₄ cycloparaffinic and isoparaffinic hydrocarbons, more preferably primarily of C₁₀-C₁₃ cycloparaffinic and isoparaffinic hydrocarbons. It is also preferred that the aliphatic solvent is capable of meeting the standards for a food grade solvent. The currently most preferred solvent is composed primarily of Conosol 145.

Optionally and preferably, the composition will comprise one or more natural product oils, the more preferred oils are from the group consisting of cedar oil, cinnamon oil, citronella oil, clove oil, eucalyptus oil, juniper oil, tall oil, and pine oil, cedar oil (also known as cedar wood oil) is especially preferred. The treatment also requires at least one silicone based component wherein the preferred R groups may be the same or different and each is a lower alkyl group of no more that four carbons especially preferred are di-functional polymers where all copolymer R groups are methyl. Preferred treatments also comprise a crosslinker, especially preferred crosslinkers have an R group wherein any alkoxy group has an alkyl group each comprising from 1 to 4 carbon atoms, also preferred are those that further comprise methyl groups at each non-alkoxy position.

The preferred method of treatment useful for improving the properties of wood for use as a construction material that comprises contacting wood with a mixture of the following components: (1) at least 70% by weight of an aliphatic solvent composed primarily of C₇-C₁₆ straight chain aliphatic, cycloparaffinic and isoparaffinic hydrocarbons, that contains less than 0.5% aromatics; (2) at least a biologically effective amount by weight of a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) at least 10% of a silicone based polymer that comprises a mixture of (A) a base copolymer of silicone units having the general formula: (MₐD_{b}T_{c}Q_{d} where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a crosslinker having a general (MₐD_{b}T_{c}Q_{d})ₓ formula the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be hydrolysable and (C) a crosslinking catalyst wherein the base copolymer is 75 to 90% by weight and the cross linker is 9 to 24% by weight and the catalyst is 1 to 5% by weight of the component and cedar oil, cinnamon oil, citronella oil, clove oil, eucalyptus oil, juniper oil, tall oil, and pine oil, cedar oil (also known as cedar wood oil) is especially preferred.

The invention may also be considered as the composition useful in the claimed treatment for improving the properties of wood for use as a construction material that comprises a mixture of the following components: (1) an aliphatic solvent composed primarily of C₇- C₁₆ straight chain aliphatic, cycloparaffinic and isoparaffinic hydrocarbons, that contains less than 0.5% aromatics; (2) a biologically effective amount of a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) a silicone based polymer that comprising a mixture of (A) a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a cross linker having a general (MₐD_{b}T_{c}Q_{d})ₓ formula the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be hydrolysable and a crosslinking catalyst. Preferred compositions are those wherein the base copolymer is 75 to 90% by weight and the cross linker is 9 to 24% by weight and the catalyst is 1 to 5% by weight of the component and the overall mixture is from 65 to 85% by weight aliphatic solvent, at least a biologically effective amount of an essential oil and the silicone based polymer is at least 5% by weight. The compositions are those described in the preferred methods as set out above. The composition also comprises a catalyst that promotes film formation in the silicone based component. While any catalyst maybe used preferred catalysts are metal soaps, especially preferred are polymerization catalysts selected from the group consisting of metal salts of alkylcarboxylic acids having from 2 to 18 carbons, and more especially preferred metal soaps are tetraalkyl titanates or zirconates.

Protection of wood and other cellulose based materials against dimensional changes can also be achieved by exclusion of absorbed water from the wood fibers or lignins by contacting the surface to be protected with a reactive silicone polymer having the following characteristics: a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group. Preferred polymers are those having R¹ groups that are methyl and R² groups that are not methyl, where 70 to 99% of the groups are R¹ and 1% to 10% of R² groups have a hydroxyl, alkoxy, or acyl group. The natural viscosity of the silicone polymer limits its entry into the wood's vascular system. While surface treatment is possible with the undiluted polymer, effective penetration of the wood requires thinning of the polymer. Therefore it is helpful to dilute the silicone polymer with a diluent to lower its viscosity and enhance vascular mobility of the polymer. A suitable diluent will not be damaging to the environment or to humans or pets exposed to the treated wood. White mineral oils, or odorless mineral spirits such as an aliphatic solvent composed primarily of C₇-C₁₆ straight chain aliphatic, cycloparaffinic and isoparaffinic hydrocarbons, that contains less than 0.5% aromatics is an effective diluent for silicone polymers. Especially preferred are an aliphatic solvent composed primarily of C₉ to C₁₄, more preferably C₁₀-C₁₃ straight chain paraffinic, cycloparaffinic and isoparaffinic hydrocarbons, that contains less than 0.5% aromatics, such as Conosol 145 marketed by Penreco, Inc. of Houston Tex. A suitable composition will have at least 5% silicone material and the balance will be a solvent and optionally a biologically effective amount of an essential oil may also be included.

The invention is especially useful in treating green wood to provide dimensionally stable lumber that requires little or no additional moisture control. The invention renders many species of wood that were heretofore either too difficult to dry or to treat as now useful commercial materials.

### DETAILED DESCRIPTION OF THE INVENTION

General Description of the Invention

In order to understand the invention at its most basic level it is important to understand the basic properties of wood. According to a standard text, Simmons et al., cited above, (Captions deleted from quotation. “ . . . ” indicates deletions other than captions and [ ] indicates insertions or change in case): “ . . . [w]ood cells, or fibers, are primarily cellulose cemented together with lignin. The wood structure is about 70% cellulose, between 12% and 28% lignin, and up to 1% ash-forming materials. These constituents give wood its hygroscopic properties, its susceptibility to decay, and its strength. The bond between individual fibers is so strong that when tested in tension they commonly tear apart rather than separate. The rest of the wood, although not part of its structure, consists of extractives that give different species distinctive characteristics such as color, odor, and natural resistance to decay.

It is possible to dissolve the lignin in wood chips using chemicals, thus freeing the cellulose fibers. By further processing, these fibers can then be turned into a pulp from which paper and paperboard products are made. It is also possible to chemically convert cellulose so that it may be used to make textiles (such as rayon), plastics, and other products that depend on cellulose derivatives.

Wood is hygroscopic, meaning that it expands when it absorbs moisture and shrinks when it dries or loses moisture. This property affects the end use of wood. Although the wet (green) condition is normal for wood throughout its life as a tree, most products made of wood require that it be used in a dry condition; therefore, seasoning by drying to an acceptable moisture content is necessary.

The moisture content of wood is the weight of water it contains, expressed as a percentage of the weight of the wood when oven dry. The weight of the water in wet wood can be twice that in wood that is oven dry. . . .

In living trees the amount of moisture varies widely between different species, among individual trees of the same species, among different parts of a tree, and between sapwood and heartwood. Many softwoods have a large proportion of moisture in the sapwood and far less in the heartwood, while most hardwoods have about the same moisture content in both sapwood and heartwood. The extreme limits of moisture content in green softwoods can be shown by comparing the moisture content of the heartwood of Douglas fir and southern pine, which may be as low as 30%, to the moisture content of the sapwood of cedars and redwoods, which may be as high as 200%.

Moisture in green wood is present in two forms: in the cell cavities as free water and within the cell fibers as absorbed water. When wood dries, its cell fibers give off their absorbed water only after all the free water is gone and the adjacent cell cavities are empty. The point at which the fibers are still fully saturated, but the cell cavities are empty, is called the fiber saturation point. In most species this occurs at about 30% moisture content. The significance of this condition is that it represents the point at which shrinkage begins. Even lumber cut with a green moisture content as high as 200% [of dry weight] can dry to the fiber saturation point (30% moisture content) with no shrinkage of the wood. Only when the cell fibers begin to give off their absorbed water and start to constrict does the wood shrink.

Therefore, all of the shrinkage wood can experience takes place between its fiber saturation point and a theoretical moisture content of 0% (oven-dry condition). Within this range, shrinkage is proportional to moisture loss. Once wood has reached a 30% moisture content or below that level, for every 1% loss or gain in moisture content, it shrinks or swells, respectively, about 1/30 of the total expansion or contraction. For example, at 15% moisture content wood will have experienced half of its total possible shrinkage. However, wood in service almost never reaches a 0% moisture content because of the influence of water vapor in the surrounding atmosphere. Therefore, the total possible shrinkage is far less important than the probable shrinkage under ordinary conditions. “The dimensional changes with moisture in wood are not symmetric as noted above. The dimensional changes are greatest when measured tangentially to the grain of the wood, smaller radially and least parallel to the grain. Moisture changes have adverse effects on other cellulose materials too, and the invention is applicable to decrease moisture effects in all types of cellulose fiber materials.

The variations of the dimensions of wood with the moisture content of the surrounding air causes wood to be a less desirable construction material than materials that have no such hygroscopic character. The present invention changes the hygroscopic properties of wood by reducing the difference between the fiber saturation point and the oven dried constant weight condition. The invention provides the means to carry reactive siloxanes into the pore structures resulting in wood that has increased dimensional stability. The invention also advantageously carries natural wood protecting essential oils into the micro-pore network of the wood. Many species are so difficult to dry without destructive dimensional changes that the wood is considered commercially unusable. Some authors even classify such species as “junk wood.” The method of this invention renders many of the socalled junk woods useful by reducing the dimensional changes. It is especially useful to treat green wood as soon as possible after harvest. Treating green wood provides maximum benefit by making the wood dimensionally stable and eliminating the need for expensive moisture stabilization practices in bringing the wood to market. Downgrading finished lumber due to warping is significantly reduced when green wood is treated according to the method of the invention. The method of the invention may be carried out in a variety of conditions. A simple soaking tank wherein the material to be treated is submerged in the treatment fluid works well for many species. Many woods considered difficult to treat by prior art methods are easily treated with the method of the invention. Treatment by soaking or by spreading the treatment fluid on the surfaces of thin pieces (less than about 5 centimeters thick) is often sufficient. Alternatively, conventional treating methods may be used such as vacuum treatment, pressure treatment or combined vacuum/pressure treatments. In areas where containment of volatile organic compounds is important, use of enclosed treatment chambers and recovery of vapors by vacuum application after treatment is preferred. Especially preferred is treatment in a enclosed vessel with a vapor recovery system so that essentially none of the hydrocarbon components are released to the atmosphere. The examples set out below illustrate typical methods of the invention. While treatment may be carried out at any temperature below the boiling point of the hydrocarbon solvent, it is preferably in the range of 90° F. to 180° F. (32.2° C. to 82.2° C.), more preferably in the range of 110° F. to 150° F. (43.3° C. to 65.5° C.) most preferably at or about 130° F. (54.4° C.). The method may be practiced at any pressure, materials to be treated may be subjected to vacuum before, during or after treatment and pressure may be applied before, during or after treatment. The currently preferred pressure is in the range of 50 to 250 psi (3.44 bar to 17.23 bar) more preferably 100 to 200 psi (6.89 bar to 13.78 bar), and especially preferred is 150 psi. or 10.34 bar

### EXAMPLE 1

Preparation of Compositions of the Invention

The compositions of the invention comprises a silicone polymer that is a mixture of alkylsiloxanes having a general base formula of: (MₐD_{b}T_{c}Q_{d})ₓ

Where M is R₃SiO_{1/2}—; D is R₂SiO—; T is RSiO_{3/2}—; and Q is Si(O_{1/2})₄— and R is a generalized organic radical selected from: linear or branched hydrocarbon radicals of 1-8 carbons containing 0-1 degree of unsaturation, or phenyl, or trifluoropropyl radicals, and may optionally be substituted with a hydroxyl, alkoxy or acyloxy group of 1 to 8 carbons. A preferred embodiment is: ^{HO}MDₓM^{OH} namely a silanol endblocked polydimethylsiloxane. The preferred viscosity is 50-3500 cSt with 750-1500 cSt being especially preferred. The composition is subject to the following general parameters: The ratio of a/(c+d) is between 0 and 4 with the preferred range being 0-0.5. The ratio of b to the rest is not subject to limitation provided the final base viscosity is between 50-3500 cSt with 750-1500 being preferred. R at each position may be the same or different and will be predominately methyl. All R groups being methyl is a preferred choice. However, at least one R group of each molecule must include a hydrolysable group such as hydroxy, alkoxy or acyloxy with hydroxy being preferred. The silicone polymer may include a further component capable of crosslinking of the general formula (MₐD_{b}T_{c}Q_{d})ₓ where M, D, T and Q are as defined above and meeting the following parameters: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group. The silicone polymer may also comprise mixtures of the polymer and the cross linker, and may further comprise a catalyst. Preferred silicone polymers form films in the presence of moisture. Any catalyst that promotes crosslinking may be used. Preferred catalysts are metal soaps, especially preferred are alkyl titanate and alkyl zirconates.

The preferred silicone polymers comprise from 75 to 90% of base polymer more preferably 80 to 85%, most preferable about 82.6% and from 10 to 25% cross linker more preferably 10 to 17% , most preferably 15% and from 1 to 5% of a catalyst preferably 2 to 3% and most preferably 2.4%. The presently preferred silicone polymer is available from GT Products, Grapevine Tex. as GT 5814.

The silicone is diluted with an aliphatic solvent composed primarily of C₇-C₁₆ straight chain aliphatic, cycloparaffinic and isoparaffinic hydrocarbons, that contains less than 0.5% aromatics. Preferably, the aliphatic solvent selected is composed primarily of C₉-C₁₄ cycloparaffinic and isoparaffinic hydrocarbons, more preferably primarily of C₁₀-C₁₃ cycloparaffinic and isoparaffinic hydrocarbons, another preferred the aliphatic solvent is composed primarily of a solvent capable of meeting food grade standards. The currently most preferred solvent is Conosol 145 marketed by Penreco, Inc. of Houston, Tex. Other suitable solvents are available from Shell Oil Company under the name Shellsol.

Optionally a natural product oil may also be combined with the silicone polymer. The oil may be selected from the group consisting of almond bitter oil. anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, tunneric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil. anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, tunneric oil, oil of wintergreen, juniper oil, tall oil, pine oil. Preferred oils are cedar oil, cinnamon oil, citronella oil, clove oil, eucalyptus oil, juniper oil, tall oil, and pine oil. Cedar oil (also known as cedar wood oil) is especially preferred.

The natural product oils add increased protection against dimensional changes as well as providing additional qualities such as anti-insect or anti-microbial activity. For example, many natural oils such as cedar oil, cinnamon oil, citronella oil, clove oil, eucalyptus oil, juniper oil, tall oil, and pine oil are well known as insect repellants and natural pesticides. Many oils such as the citrus oils have long been used as surface treatments to polish finished wood products and protect the wood finish from moisture. The present invention carries the oil to the interior wood fibers, altering the basic moisture absorbing characteristics of the wood itself. It is believed that free hydroxyl groups of the cellulose and lignin components of the wood may undergo interactions with the silicone polymer resulting in a decrease in the ability of these groups to hydrogen bond with free water. The effect may also be the result of the self organization of the silicone polymer to from a layer adjacent the wood fiber which has a hydrophilic side adjacent the wood and a hydrophobic side adjacent the bore of the micro-pores, which may also attract molecules of the hydrocarbon carrier and the optionally present natural product oil to render the interior surfaces of the micro-pores as well as the exposed surfaces less prone to wetting by water and more prone to wetting by oils. Alternatively the silicone polymer may form a hydrophobic film within the bore of the micro-pore, creating a barrier to water reaching the cellulose fiber to be bound. The invention may form a film or monolayer with any type cellulose fiber, and again the invention is not restricted solely to treating wood.

The over all composition requires a silicone polymer as described above with either a low viscosity or sufficient aliphatic solvent to carry the silicone polymer into the micro-pore structure of the wood, or into contact with the interior cellulose fibers in other products. The preferred overall composition is from 65 to 95% by weight aliphatic solvent, and the silicone based polymer is at least 5% by weight. Optionally the composition includes up to about 5% by weight natural product oil. The composition is prepared as follows: In a power stirred vessel is placed a volume of aliphatic solvent and the silicone based polymer is slowly added with stirring. When the desired volume of silicone based polymer is added, the desired volume of essential oil is slowly added to make up the final mixture. In this manner compositions of 5% Cedar oil in 65% Conosol 145/ 30% GT 5814; 75% Conosol 145/ 20% GT 5814; 80% Conosol 145/ 15% GT 5814 and 85% Conosol 145/ and 10% GT 5814 are prepared. Samples of commercially available oak, maple, yellow pine, and western pine are treated by immersion in each mixture. After treatment the effect of humidity on the treated wood is observed to be reduced in each instance relative to untreated wood. When the wood is exposed to liquid water the water is observed to bead on the surface and not to wet the surface. In the untreated samples liquid water readily wets the wood.

### EXAMPLE 2

Dimensional Stability:

Simmons et al., FIG. 6.1-11 shows that a 50 mm by 250 mm (nominal 2 inch×10 inch) shrinks 19.1 mm (¾ inch) with a change in moisture form the fiber saturation point of 30% (green wood) to the 0 moisture condition. Further the dried wood swells as the fibers take up moisture from the natural humidity of the surrounding air changing about 0.064 mm (0.0025 inch) per 25 mm of wood (1 inch) for a change of 1% in fiber moisture content between 0 and 30%. In contrast to the reported shrink and swell of untreated wood, when wood is treated according to the invention by immersion in a composition prepared as described in example 1 consisting of 85% Conosol 145, 10% GT 5814, and 5% cedar wood oil, the shrink and swell natural properties of the wood are stabilized and the wood dimensions change in face width tangential to the grain by less than 0.03 mm per 25 mm over the humidity range of 0 to 100% humidity change in the ambient air.

### EXAMPLE 3

Bending Strength Increase

Two substantially equivalent nominal 2 inch by 4 inch by 8 feet Short Leaf Yellow Pine boards were purchased from a retail chain home improvement center in the Houston, Tex. metropolitan area. One board was treated according to the invention by immersion in a composition prepared as described in example I consisting of 85% Conosol 145, 10% GT Products 5814, and 5% cedar wood oil for one hour, and then being permitted to air dry for two days. The other board was not treated. The boards were supported at the ends by being placed on blocks and a 20 kg weight (44 pound) was placed at the center and the deflection of the board was measured. The treated board deflection was more than 50.8 cm (2 inches) less than the deflection of the untreated board.

### EXAMPLE 4

Hygroscopic Behavior

Two samples of 22.5 mm×89 mm (1 in. by 4 in.) southern short leaf pine were dried to constant weight by heating in an oven at 110 deg. C. and weighing daily until no weight change was observed. One sample of the wood was then treated as described above, dried for several days and then placed in a chamber maintained at 100% humidity. The samples were weighed daily and the weights in grams are reported in Table 1 below.

TABLE 1

| Sample | 1 | 2 | 3 | 4 | 5 | 6 | 7 |
|---|---|---|---|---|---|---|---|
| #45-A-1 | 298 | 298 | 298 | 298 | 298 | 299 | 298 |
| untreated | 285 | 293 | 297 | 301 | 306 | 308 | 310 |

As shown above the treated sample did not gain weight by absorbing moisture from the atmosphere, while the untreated control showed the typical hygroscopic behavior of wood.

### EXAMPLE 5

Interior Penetration of Wood

A copolymer solution suitable for treating wooden materials according the invention is prepared by slowly adding 10 parts of a silicone polymer obtained from GT Products, Inc. of Grapevine, Tex. designated GT 5814 to 85 parts of Conosol 145 with 5 parts cedar oil, based on the total volume of the final mixture. When the addition is complete, 4 foot sections cut from building grade 8 foot pine 2×4s are immersed in a tank of circulating solution for one hour and dried to constant weight. The untreated 4 Ft section of each 2×4 was marked and used as a control in subsequent tests.

Randomly selected treated and the matching untreated 2×4s were split and the interior portions of the split wood was sprayed with water. The treated wood showed water beading even in the center of the material while all surfaces of the untreated portions were readily wet, showing complete penetration of the copolymer to the interior of the wood. Interior penetration was further demonstrated by a variation of the American Wood Preservation Association (AWPA) standard test for measuring penetration of the oil carried preservative pentachlorophenol (penta) in a light colored hydrocarbon carrier (AW3-00-5). The test uses a mixture of 20 parts finely divided calcium carbonate or “Speedex” filter aid powder and 1 part Oil Red 0 (as known as Sudan red, Calco Oil Red, or Oil Red 235). Peneration by the oil carrier is detected by brushing the dye mixture on the surface of the cut section and the presence of oil is indicated by spreading of the red dye. In the case of the present invention use of the same oil detection method detects the carrier and the cedar oil component, one inch sections were cut from the center of treated 8 ft (2.43 meter) treated 2×4 (50.8mm×101.6 mm) southern yellow pine and SPF lumber. The Red Oil 0 reagent is applied to the surface and read after 5 minutes. The presence of an oil was confirmed by the spread of the oil soluble red stain. Untreated controls showed no or very little spreading. Oil was detected in samples up to 24 months after treatement (the oldest samples available for testing). Peneration of the silicone component was confirmed by gravimetric analysis. While untreated wood show typical ash residues of about 1%, of the dry weight of the untreated wood, treated samples show an increase of an additional 1 to 2% of dry weight. This amount is consistent with the expected retention of the silicone component in the treatment fluid. While the hydrocarbon components burn off as water and carbon dioxide, the silicone is converted to silica (SiO₂) a major component of ash. Ash weight increases are uniform across the samples indicating that the silicone component penetrates to the center of the 2×4 dimensioned stock

### EXAMPLE 6

Warp Prevention in Cottonwood Treated Green

A green cottonwood cant, shipped within 2 days of harvest wrapped in a water retaining plastic film, was unwrapped and immediately treated in a mobile treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the same composition as that described in Example 5 (85% Conosol 145, 10% GT 5814 and 5% cedar oil) pressurizing the chamber to 150 psi (10.34 bar) and holding for 1 hour, then venting the chamber and removing the treated wood from the treatment chamber. The treated cottonwood cant was allowed to stand exposed to elements out doors for 9 days before the first sample was cut and 16 days before the second sample was cut. The degree of warping was estimated by laying the sample on the saw table and measuring the maximum deflection of the piece from the flat surface. The 9 day cured sample was found to have a slight cup of less than 3 mm on the 75 mm section (tangential to the grain). The 16 day cured sample showed no significant warping even after storage for an additional two weeks open to the elements in Spring, Tex. During the exposure period the weather changed from quiet dry to a rainfall of greater than 25 mm.

### EXAMPLE 7

Warp prevention in Hemlock Treated Green

A green Hemlock about 50mm×125mm×1 meter, shipped within 2 days of harvest wrapped in a water retaining plastic film, was unwrapped and immediately treated in a mobile treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the same composition as that described in Example 5 (85% Conosol 145, 10% GT 5814 and 5% cedar oil) pressurizing the chamber to 150 psi and holding for 1 hour. then venting the chamber and removing the treated wood from the treatment chamber. The treated sample was allowed to stand exposed to elements out doors for 16 days before evaluation The degree of warping was estimated by laying the sample on the saw table and measuring the maximum deflection of the piece from the flat surface. The cured sample was found to have a slight twist of less than 3 mm on the 50 mm section (tangential to the grain). Storage was open to the elements in Spring, Tex. During the exposure period the weather changed from quiet dry to a rainfall of greater than 25 mm.

### EXAMPLE 8

Warp Prevention in Sycamore Treated Green

A green Scymore slab, was treated within 3 days of harvest in a mobile treatment vessel by closing the wood to be treated in an enclosed treatment chamber. pulling a vacuum of 28 mm Hg on the treatment chamber for 30 minutes, releasing the vacuum and filling the treatment chamber with a treatment fluid having the same composition as that described in Example 5 (85% Conosol 145, 10% GT 5814 and 5% cedar oil) pressurizing the chamber to 150 psi and holding for 1 hour at 130° F. (54.4° C.), then venting the chamber and removing the treated wood from the treatment chamber. The treated sycamore was allowed to stand exposed to elements out doors for 6 months. The untreated control from the same slab twisted and cracked to a degree that it would have been unuseable for any purpose except chipping or burning. The treated slam remained stable showing only superficial checks on the ends and no significant cracks.

### EXAMPLE 9

Warp Prevention in Mulberry Treated Green

A green mulberry slab, was treated less than 2 days after harvest in a mobile treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the same composition as that described in Example 5 (85% Conosol 145, 10% GT 5814 and 5% cedar oil) pressurizing the chamber to 150 psi and holding for I hour at 130° F. (54.4° C.), then venting the chamber and removing the treated wood from the treatment chamber. The treated mulberry slab was allowed to stand exposed to elements out open to the elements in Spring, Tex. for over six months. During the exposure period the weather changed from quiet dry to a rainfall of greater than 25 mm.

### EXAMPLE 10

Warp Prevention in Kiln Dried SPF

Kiln dried commercial SPF lumber purchased from a major building materials chain nominally 2×4×8 ft (50mm×100 mm×2.6 meters) were treated in a mobile treatment vessel by closing the wood to be treated in an enclosed treatment chamber, pulling a vacuum of 28 mm Hg on the treatment chamber for 30 minutes. releasing the vacuum and filling the treatment chamber with a treatment fluid having the same composition as that described in Example 5 (85% Conosol 145, 10% GT 5814 and 5% cedar oil) pressurizing the chamber to 150 psi and holding for 1 hour, then venting the chamber and removing the treated wood from the treatment chamber. The treated lumber was stored open to the elements in Spring, Tex. for 6 months. During the exposure period the weather changed from quiet dry to a rainfall of greater than 25 mm. The samples displayed no significant warping while controls from the same batch warped so badly as to be completely unuseable as building materials. Similar results were obtained by soaking the lumber for two hours at 130° F. (54.4° C.)

### EXAMPLE 11

Warp Prevention in Kiln Dried Southern Yellow Pine (SYP)

Kiln dried commercial SYP lumber purchased from a major building materials chain nominally 2×4×8 ft (50 mm×100 mm×2.6 meters) were treated in a mobile treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the same composition as that described in Example 5 (80% Conosol 145, 15% GT 5814 and 5% cedar oil) pressurizing the chamber to 150 psi and holding for 1 hour, then venting the chamber and removing the treated wood from the treatment chamber. The treated lumber was stored open to the elements in Spring, Tex. for 6 months. During the exposure period the weather changed from quiet dry to a rainfall of greater than 25 mm. The treated samples displayed no significant warping while controls from the same batch warped so badly as to be completely unuseable as building materials. Similar results were obtained by soaking the lumber in treatment fluid for two hours at 130° F. (54.4° C.)

### EXAMPLE 12

Warp prevention in Black Spruce

Black Spruce lumber nominally 2×4×8 ft (50 mm×100 mm×2.6 meters) is treated in a mobile treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the same composition as that described in Example 5 (85% Conosol 145, 10% GT 5814 and 5% cedar oil) pressurizing the chamber to 150 psi and holding for 1 hour, then venting the chamber and removing the treated wood from the treatment chamber. The treated lumber is stored open to the elements. During the exposure period the weather changes from quiet dry to a rainfall of greater than 25 mm. The samples display no significant warping while controls from the same batch warp so badly as to be completely unuseable as building materials. Similar results are obtained by soaking the lumber for two hours at 130° F. (54.4° C.)

### EXAMPLE 13

Waterproofing

In a simple test to demonstrate the ability of the polymer to water proof cellulose material samples of pine wood, cotton balls, oak, birch and maple are treated with a copolymer consisting substantially of hydoxymethyl endblocked dimethylsiloxanes having a viscosity of 1000 cSt by immersion in a stirred bath of copolymer at room temperature for one hour and allowing the article to dry to constant weight after treatment. When the treated articles were sprayed with liquid water the water beaded and did not wet the treated surface, where as untreated samples of the same material were quickly wet with little or no evidence of water beading.

### EXAMPLE 14

Interior Waterproofing of Wood

A copolymer solution suitable for treating wooden materials according the invention is prepared by slowly adding 10 parts of a silicone polymer obtained from GT Products, Inc. of Grapevine, Tex. designated GT 5814 to 85 parts of Conosol 200 and 5 parts Cedar oil, based ion the volume of the final mixture. When the addition is complete, 4 foot sections cut from building grade 8 foot pine 2×4s are immersed in a tank of circulating solution for one hour and dried to constant weight. The untreated 4 ft section of each 2×4 was marked and used as a control in subsequent tests. Randomly selected treated and the matching untreated 2×4s are split and the interior portions of the split wood was sprayed with water. The treated wood showed water beading even in the center of the material while all surfaces of the untreated portions were readily wet showing complete penetration of the copolymer to the interior of the wood. Interior pentration of the oil is also demonstrated by staining with Oil Red 0 as described in Example 5 above.

### EXAMPLE 15

Strength Increase

Substantially equivalent nominal 8 feet Pine 2×4s were purchased from a retail chain home improvement center in the Houston, Tex. metropolitan area. Randomly selected boards were cut into two 4 foot sections and marked, one section was retained as a control and the other was treated according to the invention by imniersion in a composition of 85% Conosol 145, 10% GT 5814, and 5% cedar wood oil for one hour, and then being permitted to air dry for several days. The 4 foot section boards were then tested to breaking for strength retention in static bending. The test pieces were supported at the ends and a hydraulic jack with a gauge indicated the applied pressure was applied at the center until the test piece broke. Two separate sample sets of short leaf southern pine were tested. The pressure was applied to the center of the span on the 4 inch width, toward the 2 inch dimension. Sample 1 untreated failed at 400 pounds applied pressure after bending 2.25 in, and broke cleanly in to two separate pieces. Sample 1 treated failed at 900 pounds after bending 1.25 in. and the break was with long shards, with many bent shards remaining attached. Sample 2 untreated failed at 600 pounds with a 1.25 in bend, and again broke cleanly. Sample 2 treated failed at 2000 pounds, and again splintered rather than breaking cleanly. Examination of the broken, treated samples showed that the treatment was distributed through out the piece with no evidence of untreated areas.

### EXAMPLE 16

Warp Prevention with Other Essential Oils

SYP lumber samples were cut from two selected boards one with the growth rings tangential to the long dimension and one board with the long dimension radial to thegrowth rings, each nominally 2″×4″×1″ (50.8 mm×100 mm×25.4 mm). Each sample is treated in a small treatment vessel by closing the wood to be treated in an enclosed treatment chamber, pulling a vacuum of 28 mm Hg on the treatment chamber for 30 minutes, releasing the vacuum and filling the treatment chamber with a treatment fluid having the composition as set out in the table below, venting the chamber to atmospheric pressure and holding for 1 hour. The treated lumber is then cured for 12 hours and immersed in water for 2 hours. The untreated control exhibits substantial cupping on both samples most pronounced on the tangential cut. The treated samples set out below all show improved dimensional stability over the controls. Treatment compositions were as follows

TABLE 2

| | Percent | Percent | Percent |
|---|---|---|---|
| Essential Oil | oil | GT 5814 | Conosol 145 |
| almond bitter oil | 5 | 10 | 85 |
| anise oil | 5 | 10 | 85 |
| basil oil | 5 | 10 | 85 |
| bay oil | 5 | 10 | 85 |
| caraway oil | 5 | 10 | 85 |
| cardamom oil | 5 | 10 | 85 |
| cedar oil | 5 | 10 | 85 |
| celery oil | 5 | 10 | 85 |
| chamomile oil | 5 | 10 | 85 |
| cinnamon oil | 5 | 10 | 85 |
| citronella oil | 5 | 10 | 85 |
| clove oil | 5 | 10 | 85 |
| coriander oil | 5 | 10 | 85 |
| cumin oil | 5 | 10 | 85 |
| dill oil | 5 | 10 | 85 |
| eucalyptus oil, | 5 | 10 | 85 |
| fennel oil | 5 | 10 | 85 |
| ginger oil | 5 | 10 | 85 |
| grapefruit oil, | 5 | 10 | 85 |
| lemon oil | 5 | 10 | 85 |
| lime oil | 5 | 10 | 85 |
| mint oil | 5 | 10 | 85 |
| parsley oil | 5 | 10 | 85 |
| peppermint oil | 5 | 10 | 85 |
| pepper oil | 5 | 10 | 85 |
| rose oil | 5 | 10 | 85 |
| spearmint oil | 5 | 10 | 85 |
| (menthol) | | | |
| sweet orange oil | 5 | 10 | 85 |
| thyme oil | 5 | 10 | 85 |
| turmeric oil | 5 | 10 | 85 |
| oil of wintergreen, | 5 | 10 | 85 |
| juniper oil | 5 | 10 | 85 |
| tall oil | 5 | 10 | 85 |
| pine oil | 5 | 10 | 85 |
| almond bitter oil | 1 | 19 | 80 |
| anise oil | 1 | 19 | 80 |
| basil oil | 1 | 19 | 80 |
| bay oil | 1 | 19 | 80 |
| caraway oil | 1 | 19 | 80 |
| cardamom oil | 1 | 19 | 80 |
| cedar oil | 1 | 19 | 80 |
| celery oil | 1 | 19 | 80 |
| chamomile oil | 1 | 19 | 80 |
| cinnamon oil | 1 | 19 | 80 |
| citronella oil | 1 | 19 | 80 |
| clove oil | 1 | 19 | 80 |
| coriander oil | 1 | 19 | 80 |
| cumin oil | 1 | 19 | 80 |
| dill oil | 1 | 19 | 80 |
| eucalyptus oil, | 1 | 19 | 80 |
| fennel oil | 1 | 19 | 80 |
| ginger oil | 1 | 19 | 80 |
| grapefruit oil, | 1 | 19 | 80 |
| lemon oil | 1 | 19 | 80 |
| lime oil | 1 | 19 | 80 |
| mint oil | 1 | 19 | 80 |
| parsley oil | 1 | 19 | 80 |
| peppermint oil | 1 | 19 | 80 |
| pepper oil | 1 | 19 | 80 |
| rose oil | 1 | 19 | 80 |
| spearmint oil | 1 | 19 | 80 |
| (menthol) | | | |
| sweet orange oil | 1 | 19 | 80 |
| thyme oil | 1 | 19 | 80 |
| turmeric oil | 1 | 19 | 80 |
| oil of wintergreen, | 1 | 19 | 80 |
| juniper oil | 1 | 19 | 80 |
| tall oil | 1 | 19 | 80 |
| pine oil | 1 | 19 | 80 |
| almond bitter oil | 3 | 12 | 85 |
| anise oil | 3 | 12 | 85 |
| basil oil | 3 | 12 | 85 |
| bay oil | 3 | 12 | 85 |
| caraway oil | 3 | 12 | 85 |
| cardamom oil | 3 | 12 | 85 |
| cedar oil | 3 | 12 | 85 |
| celery oil | 3 | 12 | 85 |
| chamomile oil | 3 | 12 | 85 |
| cinnamon oil | 3 | 12 | 85 |
| citronella oil | 3 | 12 | 85 |
| clove oil | 3 | 12 | 85 |
| coriander oil | 3 | 12 | 85 |
| cumin oil | 3 | 12 | 85 |
| dill oil | 3 | 12 | 85 |
| eucalyptus oil, | 3 | 12 | 85 |
| fennel oil | 3 | 12 | 85 |
| ginger oil | 3 | 12 | 85 |
| grapefruit oil, | 3 | 12 | 85 |
| lemon oil | 3 | 12 | 85 |
| lime oil | 3 | 12 | 85 |
| mint oil | 3 | 12 | 85 |
| parsley oil | 3 | 12 | 85 |
| peppermint oil | 3 | 12 | 85 |
| pepper oil | 3 | 12 | 85 |
| rose oil | 3 | 12 | 85 |
| spearmint oil | 3 | 12 | 85 |
| (menthol) | | | |
| sweet orange oil | 3 | 12 | 85 |
| thyme oil | 3 | 12 | 85 |
| turmeric oil | 3 | 12 | 85 |
| oil of wintergreen, | 3 | 12 | 85 |
| juniper oil | 3 | 12 | 85 |
| tall oil | 3 | 12 | 85 |
| pine oil | 3 | 12 | 85 |
| cedar oil | 1 | 4 | 95 |
| cedar oil | 5 | 20 | 75 |
| cedar oil | 5 | 25 | 70 |

We claim:

1. A composition useful for improving the properties of cellulose objects that comprises a mixture of the following components: (1) an aliphatic solvent composed primarily of C₇-C₁₆ straight chain aliphatic, cycloparaffinic and isoparaffinic hydrocarbons, that contains less than 0.5% aromatics; (2) a natural product oil selected from the group consisting of almond bitter oil, anise oil. basil oil, bay oil, caraway oil, cardamom oil, cedar oil, celery oil, chamomile oil. cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) a silicone based polymer that comprising a mixture of (A) a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a cross linker having a general (MₐD_{b}TCQ_{d})x formula the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and a polymerization catalyst wherein the base copolymer is 75 to 90% by weight and the cross linker is 9 to 24% by weight and the catalyst is 1 to 5% by weight of the component and the overall mixture is from 65 to 85% by weight aliphatic solvent, at least a biologically effective amount of an essential oil and the silicone based polymer is at least 5% by weight.

2. The composition of claim 1 comprising the aliphatic solvent (1) and the solvent selected is composed primarily of C₉-C₁₄ cycloparaffinic and isoparaffinic hydrocarbons.

3. The composition of claim 1 comprising the aliphatic solvent (1) and the solvent selected is composed primarily of C₁₀-C₁₃ cycloparaffinic and isoparaffinic hydrocarbons.

4. The composition of claim 1 comprising the aliphatic solvent (1) and the solvent selected is composed primarily of a food grade solvent.

5. The composition of claim 1 comprising the aliphatic solvent (1) and the solvent selected is composed primarily of Conosol 145.

6. The composition of claim 1 wherein an oil (2) is selected and further the oil is from the group consisting of cedar oil, cinnamon oil, citronella oil, clove oil. eucalyptus oil, juniper oil, tall oil, and pine oil.

7. The composition of claim 1 wherein an oil (2) is selected and further the oil is cedar oil.

8. The composition of claim 1 wherein R groups may be the same or different and each is a lower alkyl group of no more that four carbons.

9. The composition of claim 1 that comprises a where all copolymer R groups are methyl.

10. The composition of claim 1 that comprises a cross linker wherein each R group in the alkoxy groups is an alkyl group comprising from I to 4 carbon atoms.

11. The composition of claim 1 that further comprises methyl groups at non-alkoxy position.

12. A composition of matter useful for improving the properties of wood for use as a construction material that comprises a mixture of the following components: (1) at least 70 percent by weight of an aliphatic solvent composed primarily of C₇-C₁₆ straight chain aliphatic, cycloparaffinic and isoparaffinic hydrocarbons, that contains less than 0.5% aromatics; (2) up to 5% by weight of a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; or up to 5% by weight of a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) at least 10% by weight of a silicone based polymer that comprising a mixture of (A) a base copolymer of silicone units having the general formula: (MₐD_{b}T_{c}Q_{d})ₓ where M is R₃SiO_{1/2}—; D is R₂SiO—; T is RSiO_{3/2}—;
Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a cross linker having a general (MₐD_{b}T_{c}Q_{d})x formula the following parameters apply: the ratio of a/(c+d) is between 0 and 4; the ratio of b to the rest is not subject to limitation provided the final cross linker viscosity is below 350 cSt; and R is a generalized organic radical selected from: linear or branched hydrocarbon radicals of 1-8 carbons containing 0-1 degree of unsaturation of phenyl, or trifluoropropyl radicals and at least one R group of each molecule must be a and a polymerization catalyst selected from the group consisting of metal salts of alkyl carboxylic acids having from 2 to 18 carbons.

13. The composition of claim 12 comprising the aliphatic solvent (1) and the solvent selected is composed primarily of C₉-C₁₄ cycloparaffinic and isoparaffinic hydrocarbons.

14. The composition of claim 12 comprising the aliphatic solvent (1) and the solvent 15 selected is composed primarily of C₁₀-C₁₃ cycloparaffinic and isoparaffinic hydrocarbons.

15. The composition of claim 12 comprising the aliphatic solvent (1) and the solvent selected is composed primarily of a food grade solvent.

16. The composition of claim 12 comprising the aliphatic solvent (1) and the solvent selected is composed primarily of Conosol 145.

17. The composition of claim 12 wherein an oil (2) is selected and further the oil is from the group consisting of cedar oil, cinnamon oil, citronella oil, clove oil, eucalyptus oil, juniper oil, tall oil, and pine oil.

18. The composition of claim 12 wherein an oil (2) is selected and further the oil is cedar oil.

19. The composition of claim 12 wherein R groups may be the same or different and each is a lower alkyl group of no more that four carbons.

20. The composition of claim 12 where all copolymer R groups are methyl.
